(19) United States
(12) Patent Application Publication
(10) Pub. No.: US 2015/0213455 A1
(43) Pub. Date: Jul. 30, 2015

(54) CLIENT REQUEST WORKFLOW ASSIGNMENT USING AN ASSIGMENT TOOL

(71) Applicant: Bank of America Corporation, Charlotte, NC (US)

(72) Inventors: Kenneth Llyod Snellings, Huntersville, NC (US); Christopher A. Dubey, Alpharetta, GA (US); Amy B. Fox, Charlotte, NC (US); Kimberly Lynn Lewis, Charlotte, NC (US); Nicholas William Mason, Charlotte, NC (US); Roshon J. Slack, JR., Hartford, CT (US); Lee James Tarran, Longfield (GB); Arthur Tsirtsakis, Singapore (SG)

(73) Assignee: Bank of America Corporation, Charlotte, NC (US)

(21) Appl. No.: 14/167,734

(22) Filed: Jan. 29, 2014

(51) Int. Cl. G06Q 30/00

(52) U.S. Cl. CPC G06Q 30/016

(57) ABSTRACT

Embodiments of the present invention provide clients with single contact points for communication channels in order to submit client requests for accounts in various regions. Depending on the type of client and the type of client request, the client requests are routed to the appropriate representatives for resolving the client requests without passing off the clients to multiple representatives that handle different types of client requests. The representatives may include dedicated service representatives, a group of dedicated service representatives, general service representatives, a general international team of representatives working the business hours of the client, and individual regional teams of representatives. The representatives may utilize a case management tool to open cases for client requests and track the cases throughout the resolution process. Additionally, representatives may utilize an assignment tool as a source of information to determine how to route the client requests within the institution for resolution.

### FIELD

This invention relates generally to the field of global financial services, and more particularly embodiments of the invention relate to apparatuses and methods for a process that allows clients with global banking accounts in various regions across the globe to receive international support during the business hours of the clients.

### BACKGROUND

In some instances, particularly when clients have operations in a domestic country and not in international countries, it may be difficult for clients to receive the desired service from an organization for accounts located in the international countries. Clients may receive service in a primary country based on one service model, and may receive service in various international countries based on one or more other service models for one or more of the international countries in which the client desires service. Moreover, time differences between primary countries in which the client has operations and international countries in which the client does not have operations may further influence the client's ability to receive the desired service.

### BRIEF SUMMARY

Embodiments of the present invention address the above needs and/or achieve other advantages by providing apparatuses (e.g., a system, computer program product, and/or other device) and methods that help a client having operations in a primary region (or multiple primary regions) to obtain the desired service for accounts in outside regions in which the client does not have operations.

Embodiments of the present invention provide a client with a single phone number and/or a single e-mail contact (or other direct communication channel) in the primary region to handle all of the client's requests for accounts in the primary region or international regions. Depending on the type of client and the type of client request, the client request is routed to the appropriate representative for resolving the client request without passing off the client through multiple communication channels to multiple representatives that handle different types of requests.

Embodiments of the invention may differentiate how client requests are routed based on how the client requests are initiated, for example when a client request is initiated through a phone call versus when a client request is initiated through electronic written correspondence (e.g., e-mail, fax, instant messages, or other like written communication channels). Client requests may be further routed based on a difference between the types of clients, for example when a client is identified as type 1, type 2, type 3, or an Nth type client. Moreover, the client request may also be routed based on the location of the account associated with the type of client request, for example a client request for an account located in a primary region (e.g., region 1 in which the client has operations) and a client account located in an international region (e.g., region 2, region 3, Nth region in which the client does not have operations). The regions described herein may be a portion of a country, a country, a group of portions of multiple countries, a group of multiple countries, or any other type of area. Finally, the client request may also be routed based on the type of request, for example a first touch request (described herein as an “FTR”) that can be handled by a client representative or a non-first touch request (described herein as a “non-FTR”) that requires additional research from a research representative.

The term representative may be used throughout the specification with respect to different types of representatives. A dedicated service representative (hereinafter “DSR”) may be described herein as a dedicated service director (hereinafter “DSD”) that communicates directly with the client, or a dedicated service consultant (hereinafter “DSC”) that works along with or for the DSD but does not have direct contact with the clients. In some embodiments the DSRs may be used to communicate only with the type 1 and/or type 2 clients. In some embodiments each individual DSRs may be responsible for a particular client (e.g., type 1 clients) and/or a group of DSRs may be responsible for a particular client (e.g., type 2 clients). A general service representative or team of general service representatives may be described herein as contact center representatives for a contact center team or general research representatives for a general research team, or another type of general representative. The general service representative may or may not have contact with clients (e.g., a general contact center representative may have contact with clients while a general research representative may not have contact with clients). The general service representative or team of general service representatives may be used to communicate with type 3 or type N clients. In other embodiments of the invention type 2 clients may also speak with the general service representatives or team of general service representatives.

General international service representatives from a general international servicing team are used to help resolve client requests that the DSR or general service representative cannot handle by himself or herself. As such, the general international servicing team is trained to resolve client requests for client accounts in regions outside of the primary region (e.g., outside the first region), resides outside of the primary region, and is available during the business hours of the client in the primary region to resolve client requests during the initial client call or shortly thereafter (e.g., within the same day).

Regional representatives from regional teams are used to resolve client requests that cannot be handled by the DSR or general service representative, or the general international service representatives. The regional team representatives are generally not available to resolve client requests during the hours of the primary region, and as such, they generally work the business hours of the region in which they are located (e.g., region 2, region 3, region N). As such, the client representative (e.g., DSR or general service representative) is used to monitor the resolution of the client request by the regional representative and report the resolution of the client request to the client during the business hours of the client in the primary region.

Workflow representatives from a workflow team may be use to help route the client request to the proper representative (e.g., general international representative or regional representative).

These representatives and the roles for the representatives within the cross regional client service environment and system are described throughout this specification. As described herein any representative that communicates directly with the client may further be described as a client representative. Alternatively, any representative that functions to research client requests, such as workflow representatives, general international team representatives, regional team representatives, or the like may be referred to herein as research representatives. In some embodiments of the invention the client representatives may also research client requests in addition to communicating with the client.

A case management tool may be utilized by representatives in order to open cases for client requests and track the cases throughout the resolution process. Additionally, an assignment tool may be utilized in order to provide a source of information for the representatives to determine how to route the client requests within the institution for resolution.

Embodiments of the invention comprise systems, computer program products, and methods for responding to a global client request. One embodiment of the invention comprises receiving an input for a region related to a client request, wherein the input for the region is received from a representative; providing a client request type selection interface; receiving an input for a client request type, wherein the input for the client request type is received from the representative; and providing a client request details interface, wherein the client request details interface provides client request information for routing the client request.

In further accord with an embodiment, the invention comprises receiving an input indicating a representative type, wherein the representative type is a client representative or a research representative; and wherein the representative type is used to determine the client request information provided to the representative for routing the client request.

In another embodiment of the invention, the client request information for the client request displayed to the client representative comprises information to collect from the client, a first touch resolution or a non-first touch resolution indication, a service level agreement time limit, entitlement requirements, and routing information.

In yet another embodiment of the invention, when the client request is received through a phone call and the request type is a first touch resolution then the client request information indicates that the client representative can resolve the request or the client representative can contact a general international team to resolve the request. In other embodiments when the client request is received through the phone call and the request type is a non-first touch resolution then the client request information indicates that the client representative should assign the request to a workflow research team for routing.

In still other embodiments of the invention, when the client request is received through an electronic written communication and the client request can be handled by the client representative the client request is resolved by the client representative. In other embodiments, when the client request is received through the electronic written communication and the client representative is unable to handle the client request then the client request information indicates that the client representative should assign the request to a workflow research team for routing.

In further accord with an embodiment of the invention, the client request information for the client request displayed to the research representative comprises a regional team or a general international team to which the research representative should route the request.

In another embodiment of the invention, the client request information for the client request displayed to the research representative comprises how to update a case in a case management tool before routing the client request to a regional team or a general international team.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates a high level process flow for a client request service process, in accordance with one embodiment of the present invention;

FIG. 2 illustrates an overall client service process flow, in accordance with one embodiment of the present invention;

FIG. 3A illustrates a client phone service process flow for a type of client, in accordance with one embodiment of the present invention;

FIG. 3B illustrates an a client phone service process flow for a type of client, in accordance with one embodiment of the present invention;

FIG. 3C illustrates a client electronic written correspondence service process flow, in accordance with one embodiment of the present invention;

FIG. 3D illustrates a client research service process flow, in accordance with one embodiment of the present invention;

FIG. 4 illustrates a case management tool interface, in accordance with one embodiment of the present invention;

FIG. 5 illustrates a client service request interface, in accordance with one embodiment of the present invention;

FIG. 6 illustrates a case assignment tool interface for a client representative, in accordance with one embodiment of the present invention;

FIG. 7 illustrates a case assignment tool interface for a research representative, in accordance with one embodiment of the present invention;

FIG. 8 illustrates an assignment interface for the case management tool, in accordance with one embodiment of the present invention; and

FIG. 9 illustrates a system diagram for a client service environment and system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that other embodiments of the invention may involve other institutions that take the place of or work in conjunction with the financial institution to perform one or more of the processes or steps described herein as being performed by a financial institution. Still in other embodiments of the invention the financial institution described herein may be replaced with other types of businesses that offer account services to clients (e.g., inside or outside of the financial services industry).

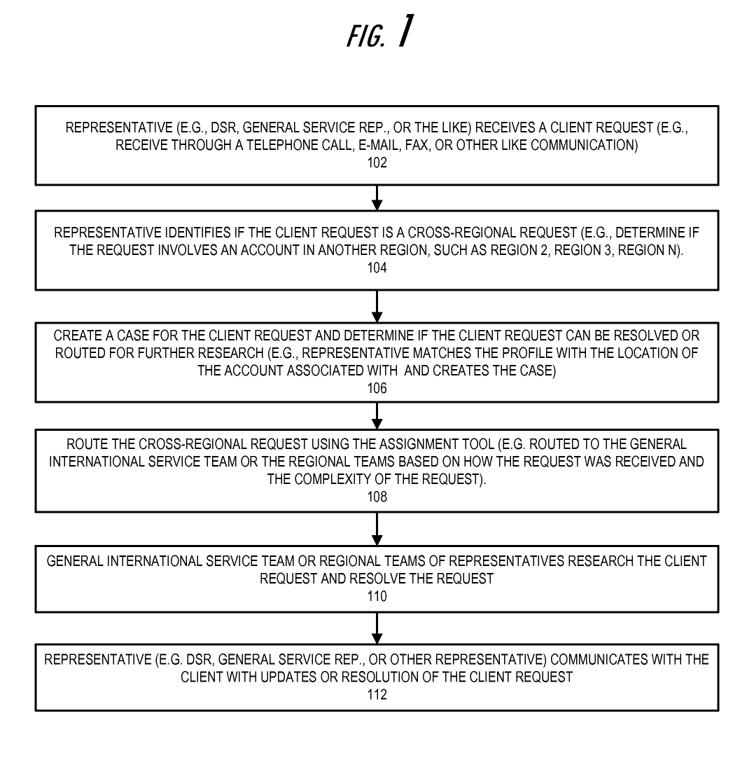

FIG. 1 illustrates a high-level process flow for a client request service process 100 for fulfilling requests from global clients, in accordance with one embodiment of the invention. As illustrated by block 102 of FIG. 1 a representative 7 of the financial institution receives a client request (also described herein as and used interchangeably with a client service request, service request, or request) from a client 9. The client's need related to the client request may include simple requests for account information, such as but not limited to account balance information, deposit information, payment information, transaction information, statement copies, or more complex account questions or actions, such as but not limited to funding information, account opening, closing, transfer information or other types of complex account actions that require more complex actions or require entitlements (e.g., documentation or other information). The client may have a single phone number, a single e-mail address, and a single fax number that the client may use when the client requires any type of service within either a primary region of the client where the client has operations (e.g., a physical presence in the primary region), or outside regions in which the client has accounts but not operations (e.g., no physical presence in the outside regions). In other embodiments the client may utilize other types of correspondence to contact representatives, such as instant messages, video calls, or another type of correspondence.

The clients that make requests may be separated into different types of clients, which may each have different needs that may be satisfied in different ways. For example, the clients may be separated as type 1, type 2, type 3, or type N (e.g., any number of client type that the financial institution uses to classify clients). Type 1 clients may have different service needs than type 2 clients, type 3 clients, and type N clients. As such the service provided for the types of clients may be completely different, may partially overlap, or may completely overlap depending on how a financial institution may separate and describe different clients 9. Depending on the type of client, when the client 9 initiates the client request, the client representative that the client 9 contacts may be a specific DSR (e.g., for a type 1), a DSR from a group of DSRs (e.g., for a type 2), or a general service representative (e.g., for a type 3), for example from a contact center, when the communication is a phone call. When the communication is an electronic written correspondence the client request may be directed to DSRs (e.g., for a type 1 and type 2) or general service representatives (e.g., for a type 3) as previously discussed with respect to the phone call. In other embodiments of the invention other types of representatives or teams of representatives may be utilized to handle various communications from the client.

As illustrated by block 104, the representative 7 that receives the call or written electronic communication (e.g., e-mail, fax, or the like) identifies if the client service request is a cross-regional request. For example, the representative may determine if the client 9 has operations in a primary region (e.g., region 1) and the client request involves an account for an outside region (e.g., region 2, region 3, or region N). For example, when the representative is authenticating the client for the client service request the representative may identify in which region the account is domiciled.

As illustrated by block 106, and explained in further detail later, the representative 7 creates a case for the client request. In some embodiments the representative 7 may be able to resolve the client request at the time of the communication (or shortly thereafter) or may be able to contact a general international team of representatives to assist in resolving the client request at the time of the communication (or shortly thereafter). However, in other embodiments if the representative 7 and/or the general international team of representatives cannot resolve the client service request at the time of the request, the representative 7 may route the client request for further researching. The case created by the representative 7 is populated with case information regarding the client request, which may include the product, request type, priority, account number, or other like information. In other embodiments if the client service request has already been created, the service request is verified for the product, request type, priority, and account number, or other like information. In some embodiments the representative 7 may create a single case, or may create multiple linked cases when the client request involves accounts in multiple regions or when the client request has multiple aspects.

Block 108 in FIG. 1 illustrates, that the service request is routed based on various factors, including but not limited to how the request was received, the type of client, and the complexity of the request. In some embodiments the representative 7, such as the client representative that received the communication, or a workflow representative from a workflow coordination team, may route the case to the international team or a specific regional team for further analysis of the client request using an assignment tool 17. In some embodiments, the representative 7 indicates within the assignment tool in which region the account is located and the request type. In response, the assignment tool 17 indicates what information is needed to resolve the request from the client, service level agreement information, entitlement requirements, where the request should be routed, and other like information.

As illustrated by block 110, and explained in further detail later, depending on the routing information from the assignment tool 17, the dedicated service representatives (DSRs), the general service representatives, the general international servicing team of representatives, or the representatives from the regional teams, and/or other representatives resolve the client request. For example, dedicated service representatives may handle type 1 and type 2 client requests over the phone themselves if it the request falls within the scope of a request that can be handled by the dedicated service representatives. Alternatively, the assignment tool 17 may indicate that a representative from a general international servicing team can handle the client request at the time of the initial communication. If the client request is more complex and requires additional research then the request may be routed to a representative at the general international servicing team or to specific regional teams based on the information provided in the assignment tool 17. In some embodiments the general international servicing team is located outside of the primary region, but works the hours of the representatives in the primary region.

Finally, as illustrated by block 112, the representative 7 (e.g., client representative) that handled the initial client communication monitors the resolution (e.g., if the research representative resolves the client request) and communicates the resolution of the client request to the client. For example, the dedicated client representative or the general service representative that handled the initial client communication (or another representative from the general service team) updates the client regarding the status of the client request and closes out the client request after it is resolved (e.g., the status is provided throughout the duration of the research or after the client request is resolved).

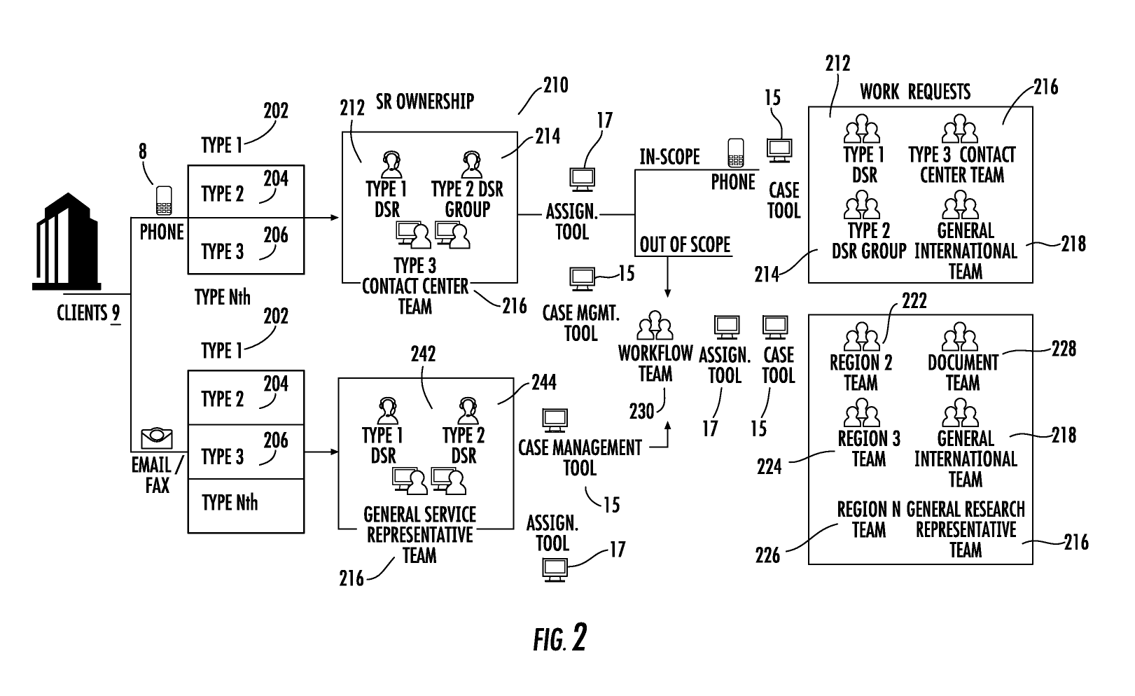

FIG. 2, illustrates a flow chart for the flow of client requests through the cross regional client service environment and system 1. As illustrated in FIG. 2, the clients 9 (e.g., clients with operations in a primary region, but with cross-regional accounts in international regions) have a single phone number and a single written communication contact (e.g., e-mail address and/or fax number) to use when the client 9 has a client service request. As illustrated in FIG. 2 the client may direct a phone call to a representative 9. Depending on the type of client making the inquiry, when the client 9 places the call to a dedicated number for the client 9 the DSR may answer the call. The DSR is often a person that has dealt with the client in the past and has the requisite knowledge to resolve various client requests. In the illustrated embodiment a type 1 DSR 212 may be provided for type 1 clients 202, such that whenever the type 1 client 202 initiates a client request the type 1 client speaks to the same type 1 DSR 212 (or a number of specific DSRs). When the client is a type 2 client the client may reach a type 2 DSR 214 that is a part of a group of dedicated DSRs for type 2 clients 204. The group of dedicated DSRs may be assigned to a particular group of clients 9, such that the clients 9 may communicate with various DSRs out of the group of DSRs over time when the client has a service request. In the illustrated embodiment a type 3 client 206 may be directed to a general service representative from a general service team 216 in which there are multiple general service representatives that are able to assist the client 9. In some embodiments of the invention the general service representative team 216 may be a call center team. Type 3 clients may be clients that rarely have client requests, and as such do not require a dedicated representative. As such the type 3 clients may never, or only rarely, speak to the same general service representative on multiple occasions.

Regardless of the representative 7 that receives the client phone call, the representative 7 may be described as a “client representative” and may authenticate the client 9 and identify the type of client request and the location of the account associated with the request. The representative 7 may create a case for the client request to track the client request by utilizing a case management tool 15, which is discussed in further detail later. The representative 7 may utilize an assignment tool 17, which is also explained in further detail later, to determine the information needed to fulfill the client request based on the type of request and the location of the account associated with the client request. If the client service request is a request that can be handled by the DSR or a general service representative from the general service representative team 216 (e.g., the request is related to an account in in a primary region in which the client 9 has operations or the request is a client request or an account in an outside region that the representative 7 can handle) the request is classified as an in-scope first touch resolution (FTR). Additionally, if the DSR or a general service representative from the general service representative team 216 cannot resolve the client request, but a representative 7 from a general international team 218 may be able to handle the request, the DSR or general service representative from the general service representative team 216 may contact the general international representative from the general international team 218 (e.g., on a separate line or conferenced into the call) to identify how to resolve the client request for the account in the outside region. This resolution of the client request would also be classified as an in-scope FTR. In some embodiments of the invention the general international representative team may be located outside of the primary region, but work the business hours of the client in the primary region. As such, a general international representative is able to resolve the client requests as FTRs during the business hours of the client in the primary region instead of having to research the request during off-hours of the primary region (e.g., during business hours of the other regions) and respond to the DSR after the initial communication (e.g., a day or two after the initial customer request). Alternatively, if the client service request requires additional researching the client service request is considered a non-FTR and is out of scope, thus requiring routing for further research by a workflow team. A representative 7 from a workflow team (e.g., a workflow representative or research representative), or the DSR or general service representative, may use the case management tool 15 to identify the information associated with the case and pass the client request to a representative 7 in general international team 218 or a representative 7 in the specific region in which the account is located (e.g., a region 2 team 222, a region 3 team 224, a region N team 226, or the like) through the use an assignment tool 17. For example, if the client request is a complex request that requires specific knowledge of the details of the financial system in a particular region, the request is sent to representatives 7 from a regional team that have an expertise in the specific region. Once the client request is resolved by any of the representatives the resolution is passed back to the type 1 DSR 212 in the case of type 1 clients 202, the type 2 DSR in the case of type 2 clients 204, and the general service representative from the general service representative team 216 or other representative, such that a client representative may provide the resolution of the client request to the client 9. It should be understood that in the present invention a financial institution may separate clients 9 into different types in a number of ways in order to provide the best service for the clients in an efficient manner based on the client's needs. As such, the clients 9 may be separated into an “Nth” type client (wherein N is substituted by any integer).

As further illustrated in FIG. 2, the clients 9 may also contact a representative 7 through an e-mail, fax, or other like written or pre-recorded correspondence. In some embodiments of the invention correspondence from all clients may be directed to DSRs, which are responsible for reviewing the client service request in the correspondence. In some embodiments the DSR may be specifically dedicated to answering e-mails or other written communication and either responding to the client request or routing client requests for further research. When the client request is routed for further research, it may be routed to other DSRs, a group of DSRs, a general service representative team, or workflow teams 230 for further routing to an international team 218, or regional teams 222, 224, 226. In some embodiments of the invention correspondence from a type 1 client 202 may be directed to a type 1 DSR 242, while correspondence from a type 2 client 204 may be directed to a DSR from a type 2 DSR group 244. In some embodiments the DSR is specifically dedicated to answering e-mails; however, in other embodiments the DSR may be the same person as the DSR described above with respect to receiving a phone call. Alternatively, correspondence from type 3 clients 206 may be handled by a general service representative from a type 3 general service representative team 216; however, in some embodiments correspondence from type 3 clients 206 may also be handled by the DSRs. The representatives 7 (e.g., DSRs or general service representatives) may open a case using the case management tool 15 and resolve the client request if the request is a request for an account in the primary region, or for a request for an account in an outside region that the representative 7 is able to handle. If the client request requires additional research the request is sent for routing by a workflow representative 7 from a workflow team 230, or other representative (e.g, DSR or general service representative), utilizing the assignment tool 17 and case management tool 15 to determine if the client request should be sent to a representative 7 at a general international team 218, a regional team (e.g., region 2 team, region 3 team), a document team 228 if additional documentation is necessary, back to a DSR, or other like representative 7. As previously discussed when the client service request is resolved by a representative 7 on one of the regional teams or the general international team, the resolution is sent back to the DSR or general service representative of the general service representative team 216 in order to inform the client 9 of the resolution of the client request.

As described herein any representative that communicates directly with the client, such as a DSR or general service representative may be referred to herein as a client representative. Alternatively, any representative that functions to research client requests, such as workflow representatives, general international team representatives, regional team representatives, or the like may be referred to herein as research representatives. In some embodiments of the invention the research representatives may also include some DSRs that are dedicated for researching client requests. For example, the DSRs may comprises of DSDs that both communicate with the client and research requests, while DSCs research resolutions to client requests and report back to the DSDs for communicating the resolutions back to the client.

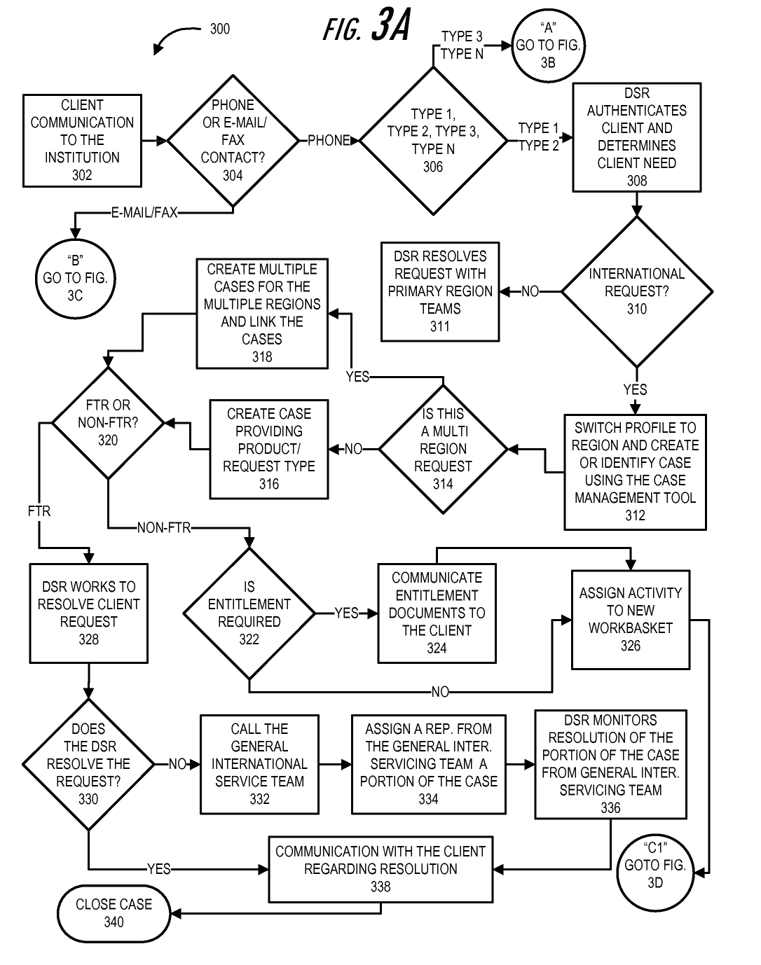

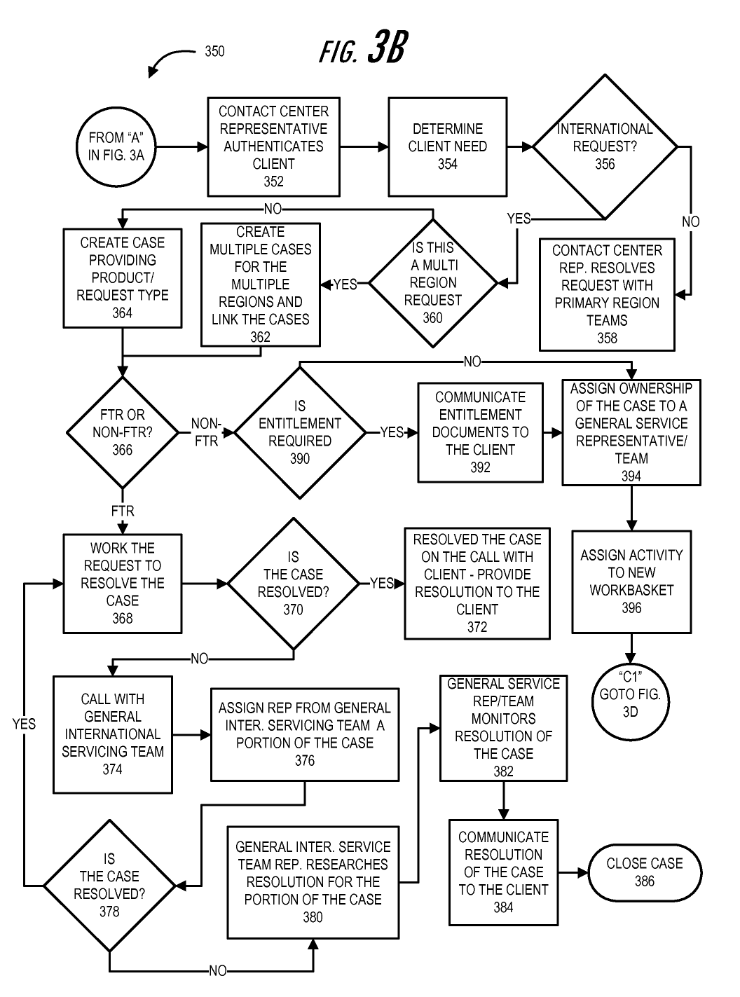

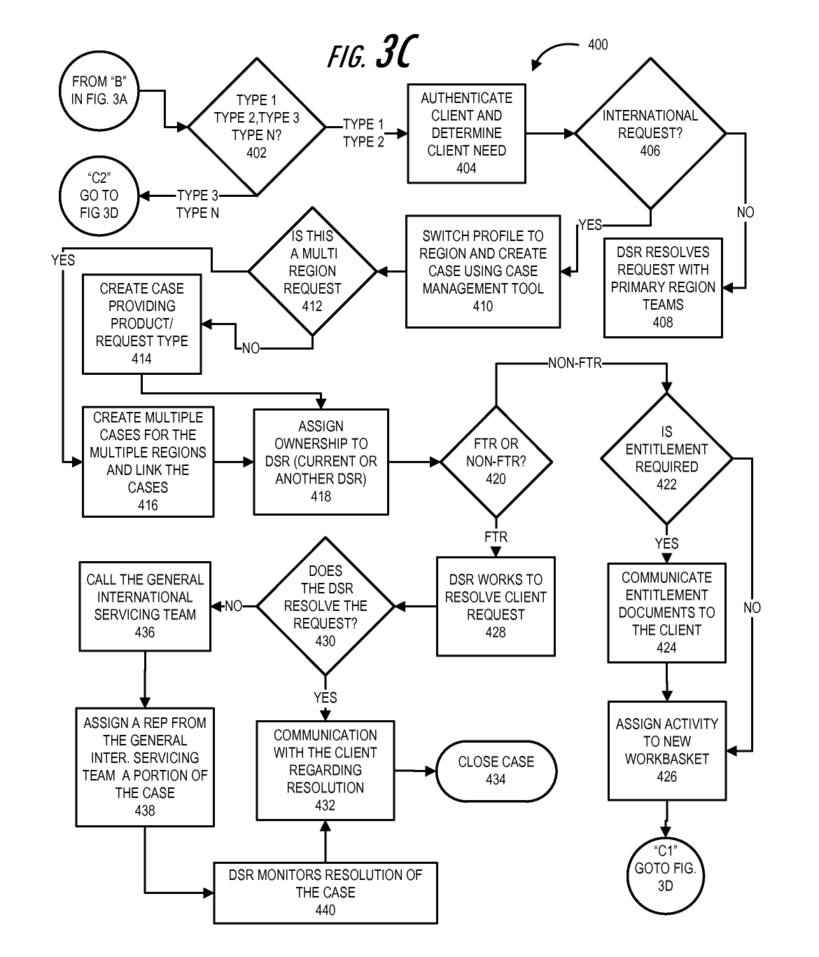

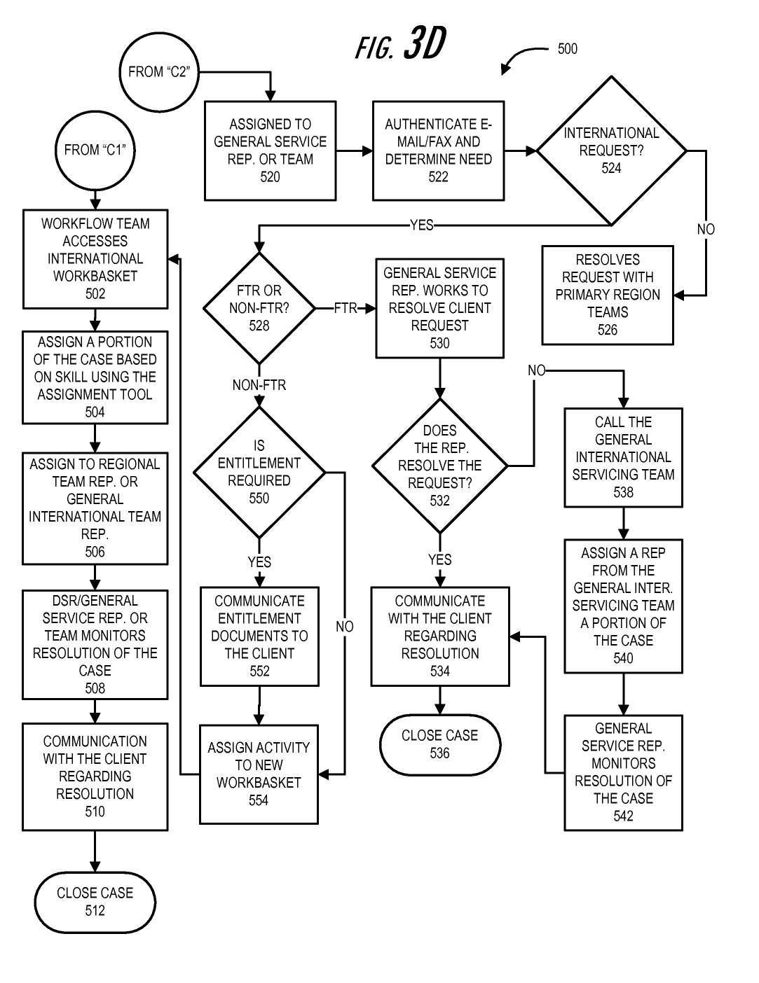

FIGS. 3A to 3D illustrate a more detailed process flow of the invention described in the high level process flow for the client request service process 100 for fulfilling service requests from global clients, which is illustrated in FIG. 1, and the flow chart for the flow of client requests through the cross regional client service environment and system 1, which is illustrated in FIG. 2.

FIG. 3A illustrates a client phone service process flow 300, in accordance with one embodiment of the present invention. As illustrated by block 302 in FIG. 3A a client communicates with the institution by calling a single number, or e-mailing a single specific e-mail address or faxing a single number (or otherwise communicating with a client through another channel using a single point of contact). As previously discussed in one embodiment, the client 9 is a customer with accounts and operations in a specific primary region (e.g., region 1) and accounts in other regions, but does not have operations in the other regions. As such instead of having multiple numbers and e-mail addresses to contact when the client has an inquiry regarding an account in an outside region, for example contact information for representatives in region 2, region 3, region N, the client 9 has a single contact that is available in the client's primary region during the business hours of the client 9.

As illustrated by decision block 304, different process steps may occur when the communication is through a telephone call and when it occurs through another type of communication channel, such as e-mail or fax. As further illustrated by decision block 306, different types of clients will also result in different types of processes. For example, type 1 clients may be large clients that have a large number of accounts in outside regions, and as such, may have client requests on a daily basis or at least a regular basis. Type 2 clients may be medium or large clients that may have client requests on a recurring basis but not as often as type 1 clients. Alternatively, type 3 clients or other types of clients (e.g., Nth type clients) may be smaller clients that have client requests, but only on a limited basis. As such, in one embodiment when a client 9 is a type 1 client or a type 2 client the a phone communication from the client 9 may be directed to a specific representative 7, such as a DSR or a representative 7 in a group of DSRs. Therefore, as illustrated by block 308, in one embodiment, when a type 1 or type 2 client contacts the institution the call may be directed to a specific DSR or a DSR from a group of DSRs that is assigned to the client account, and as such the DSRs may authenticate the client 9 and determine the client's need. For example, the contact numbers assigned to different types of clients 9 or specific clients 9 may be specific numbers that are direct lines to the assigned DSR or group of DSRs. In one embodiment of the invention the client 9 may be authenticated by the channel through which the client communications (e.g., phone number, e-mail address, letterhead, contact details, or the like), an account number provided by the client during the call, or alternatively or in addition, through the use of passwords, voice recognition (e.g., by the representative), voice recognition software, challenge questions, or other like means. In some embodiments depending on the type of client request, the client may not require authorization (e.g., when the client request is unrelated to specific account details).

As illustrated by decision block 310, the DSRs determine if the client request includes an international request. If the client request involves an account in the client's primary region, then the DSRs will handle the requests themselves or through the use of teams within the primary region as illustrated by block 311 in FIG. 3A. Alternatively, if the client request is an international request the DSRs may switch the DSR's profile to the region in which the account associated with the client request is located, as illustrated by block 312. In some embodiments, this includes the DSR utilizing a case management tool 15, which is used to create cases, track the cases, and close the cases as the client requests are identified, researched, and resolved. Switching the profile of the DSR within the case management tool 15 or the assignment tool 17 allows the DSR to view and gather specific information for the client request based on the region in which the request is located. Switching the profile of the DSR may also be required for regulatory purposes in order to capture the client request and DSR actions based on regulatory procedures in different regions.

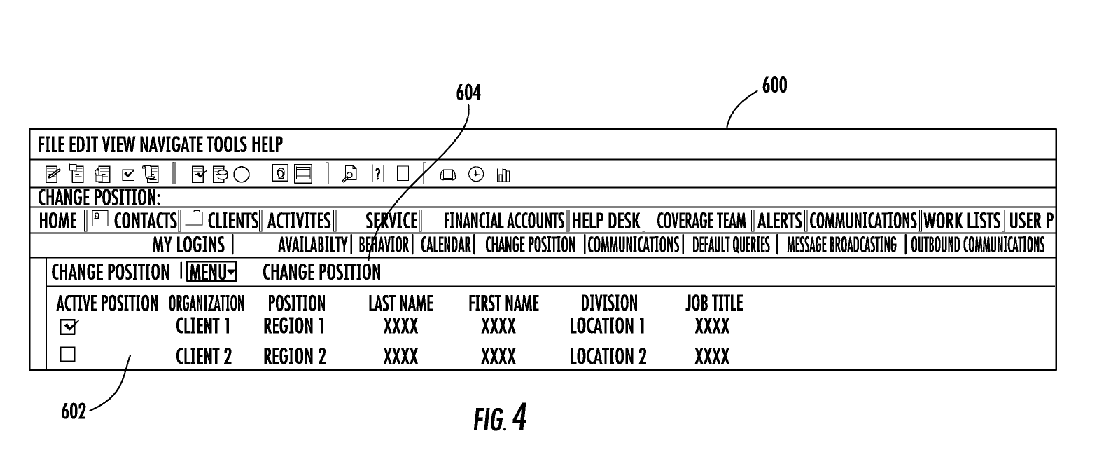

In one embodiment of the invention, an example of a case management interface 600 for the case management tool 15 is illustrated in FIG. 4. As illustrated in the case management interface 600, the interface may include a list of profiles for the representative 7. As discussed with respect to block 312 the if the client request is related to an international request located in another region, the DSR changes the profile of the DSR to the region in which the client request is located. As such, the DSR may change the profile of the case management interface 600 to another region in order to add the case for the new client request to the list of cases in the region in which the client account is located. As illustrated in FIG. 4, the DSR may change his profile by selecting from a list of profiles related to the location of the client's account and the position of the DSR handling the client request. For example, the DSR may select a profile from the list of profiles 602 and select the change position button 604. Once the profile of the DSR is changed to the proper region, the DSR may begin to create the case for the client request or review a case that has already been opened. For example, the case management interface 600 may list all of the cases opened for clients in a particular region, or all of the cases opened in a particular region for the DSR profile.

As illustrated by decision block 314, a determination is made regarding whether or not the client request is a request related to a single account in a single region or multiple accounts in multiple regions. As illustrated by block 316 if the request is for a product or account in a single region, then the DSR may begin to fill out the case. Alternatively, if the client request involves multiple regions, then as illustrated by block 318 the DSR creates multiple cases for the multiple regions for which the client request relates. For example, the client request may include a request regarding an account in an outside region, such as region 2, but may also include products from region 3, accounts in region 3, transactions involving entities in region 3, or otherwise involves information based on another region. The DSR may open cases in multiple regions and in some embodiments link the cases together under the same client request. In some embodiments, creating multiple cases may require that the DSR changes his profile before creating each separate request.

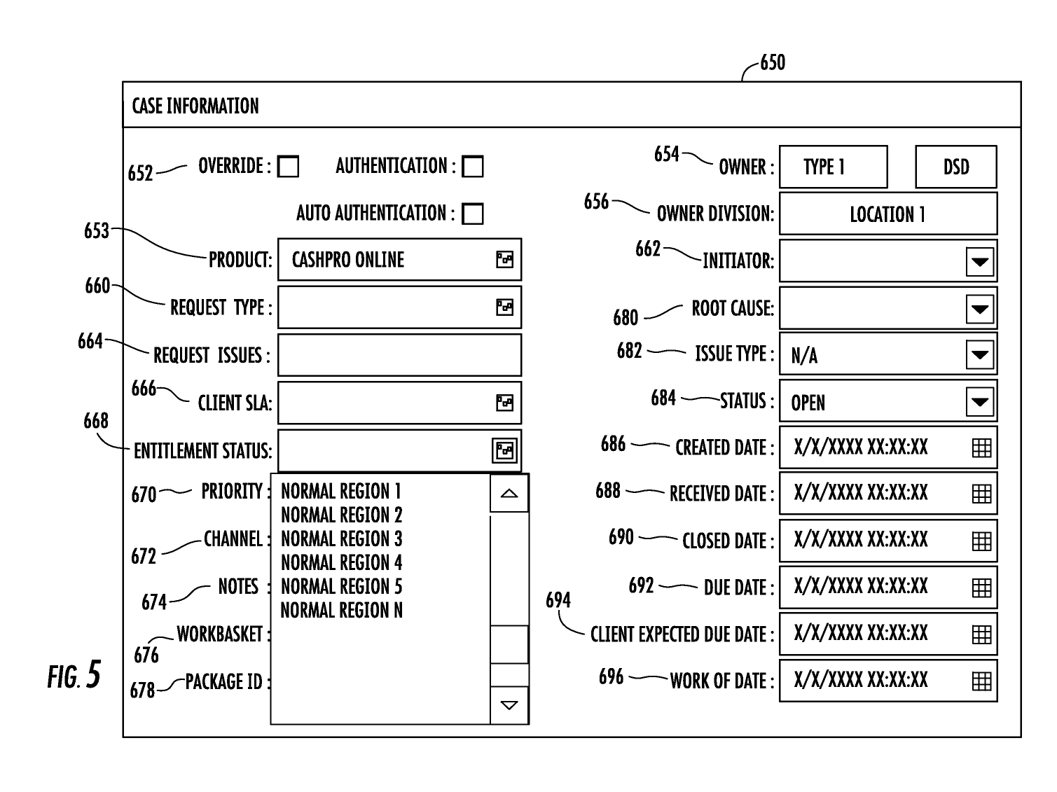

Creating a case for each client request may include entering information into the case management tool 15 through a case request information interface 650, as illustrated in FIG. 5. The case request information interface 650, illustrated in FIG. 5 may include a number of areas to enter information related to the client request. For example, the request may include an authentication section 652 that illustrates that the client has been authenticated by the DSR, automatically authenticated, or that the DSR has overridden the requirement for authentication of the client 9, such as when the DSR knows the client 9 or the client request does not require authentication. The case request information interface 650 may further include an owner section 654, illustrating the type of client 9 and the type of representative 7 assigned to handle the client 9. An owner division section 656, may further illustrate the division to which the client 9 and/or the representative 7 belongs. A product section 658 may indicate the product type for which the client request relates. A request type section 660 may indicate what type of request is being made, which indicates the type of request for the identified product. The request type 660 may be manually entered or pre-determined for consistency between client requests, and thus the request types may be included in a list of types that may be selected by the DSR or other representative 7. A request issue section 664 may indicate any potential issues associated with the request type and/or product related to the client request. The client service level agreement (SLA) section 666 may be manually or automatically populated with the SLA information related to the client 9, which indicates the time in which the institution has agreed to resolve the particular client request, or other requirements related to servicing the client request. The entitlement status section 668 may indicate entitlement documents required for the particular client 9 for the client request.

In some embodiments of the invention the case request information interface 650 further includes a priority section 670 which indicates the priority for the particular region related to the account associated with the client request. The priority section 670 may be entered first by the DSR after changing the profile of the DSR because drop down features, lists, or other automatic responses within the case request information interface 650 may be based on the selection of the priority. The priority section 670 may include both the region for which the request is based, as well as the importance of the request (e.g., low, normal, high, or the like) indicating the urgency of the request, and thus how quickly the request should be handled. The channel section 672 may indicate through which channel the request was received, such as but not limited to phone request, e-mail request, fax request, instant message request, or any other type of communication channel. This information may indicate how the request should be handled or processed, as well as how to communicate with the client in response to the client request. The notes section 674 is an area in which the DSR or other representative may be able to include additional information related to another section in the case request information interface 650, or that is not specifically included in the case request information interface 650. The workbasket section 676 may include information related to where the case should be routed, if necessary. The package ID section 678 may be an identification number that may be used in the future to access, track, research, and resolve the client request.

The case request information interface 650 may also include a root cause section 680 that indicates the root cause of the client inquiry, which may be filled out after the client request is resolved. The issue type section 682 may indicate the issue that caused the client request. The status section 684 may indicate the location in the process of resolving the client request, such as but not limited to new, open, in process, researching, closed, or other like statuses. The created date section 686 may indicate the date and time when the case for the client request was created. The received date section 688 may indicate the date and time when the client request was received (e.g., the request may be received through e-mail and the case may not be opened until the following day). The closed date section 690 indicates the date and time when the case was resolved and closed. The due date section 692 may indicate a date and time when the representative 7 thinks the client request may be resolved. The client expected due date section 694 may include the date and time when the representative 7 expects the client request to be resolved. The “work of date” section 696 may indicate the date and time when the resolution of the client request was performed.

The various sections in the case request information interface 650 may be manually entered, automatically entered, or both based on the client type, product, request type, or the like, and based on the information received in communications with the client 9.

As illustrated by decision block 320, after the DSR creates the case or multiple cases, a determination is made if the DSR currently handling the call can resolve the call as a first touch resolution (FTR) or requires additional research and/or documentation. This determination may be facilitated by the assignment tool 17, which indicates how various client requests may be handled and routed if necessary. As illustrated by decision block 322 when the client request is a non-FTR request, a determination is made as to if entitlement documentation is required. Entitlement documentation may include the necessary documentation to complete a client request. For example, the entitlement documentation may include the documentation necessary for the client to open an account, complete a transaction, or the like. As illustrated by block 324 if entitlement is required the DSR or other representative 7 communicates the necessary documents to the client 9 or directs the client 9 to a documents team 228 that helps the client 9 fulfill the entitlement requirements. If no entitlement is required the case, or at least a portion of the case that requires additional research is assigned to a new workbasket for assignment to another representative 7 that will be able to research and resolve the client request (e.g., the portion of the client request assigned), as illustrated by block 326. After the portion of the case (e.g., also described herein interchangeably as an activity) is assigned to the new workbasket the process continues to block “C1” in FIG. 3D as will be explained in further detail later.

Returning to decision block 320, if the request is an FTR request, meaning it can be handled immediately by the current DSR or another representative 7, the DSR will work to resolve the client request, as illustrated by decision block 328. A determination is made as to whether or not the DSR can resolve the request himself, as illustrated by block 330. If the client request can be handled by the current DSR, the current DSR resolves the client request and communicates the resolution to the client, as illustrated by block 338.

Alternatively, if the client request cannot be handled by the current DSR, the case may be referred to a general international servicing team 218, as illustrated by block 332. In some embodiments the DSR may put the client on hold and call the general international serving team 218 on another line. In other embodiments the DSR ends the communication with the client 9 and indicates that he will contact the client after performing additional research (e.g., speaking with the international servicing team 218). In still other embodiments a representative from the international servicing team 218 may be conferenced into the phone call with the client 9. The general international servicing team 218, in some embodiments of the invention, may be a team that is positioned in an outside region, and is tasked with handling various client requests for accounts located in various outside regions that are located outside of the client's primary region. In some embodiments, the general international servicing team 218 may work the same or similar business hours of the DSRs and/or clients 9 located in the primary region (e.g., first region). The same or similar hours may overlap the general business hours of clients working in the primary region, such as from 5 am to 8 pm (or ranges that fall within this ranges or outside of this range). As such, the general international servicing team 218 is trained to resolve client requests for accounts in regions outside of the primary region (e.g., first region), and resides outside of the primary region, but is available during the business hours of the first region to resolve client requests. As illustrated by decision block 334 the case, or at least a portion of the case, is assigned to a representative from the general international servicing team 218. As illustrated by block 336 the DSR will use the case management tool 15 to monitor the portion of the case assigned to the general international servicing representative until it is resolved. For example, the DSR will monitor the DSR's list of open cases and identify when the status of the case has been changed to resolved (or other like status identifier) by the general international servicing representative. In other embodiments of the invention, when the general international servicing representative resolves the portion of the case a notification may be sent to the DSR that the portion of the case has been resolved. In some embodiments, the DSR may be monitoring different portions of the same client request that have been sent to various representatives for research and resolution. As illustrated by block 336 after resolution of the portion of the case, the DSR will communicate the resolution of the case to the client 9. This may not occur until all of the portions of the case (e.g., multiple portions or a single portion) associated with the client request have been resolved. After the case is resolved the DSR will close the case, as illustrated by block 340.

In some embodiments if the general international team 218 cannot resolve the portion of the client request, then the DSR may follow up with the client by indicating that additional research is needed and the portion of the case may be assigned to a workbasket for further research. However, this may not occur because if additional research is needed the case would likely have been initially classified as a non-FTR for further research, as illustrated by block 320.

Returning to decision block 306, in the illustrated embodiment if the client is a type 3 client or another type of client (e.g., Nth type), as illustrated by block “A” the process moves to the client phone service process flow for an alternate client 350, as illustrated in FIG. 3B. As previously discussed, when the client 9 is a type 3 client 206, the single contact number may be a number for a general service representative team 216 (e.g., contact center team) at which a number of general service representatives (e.g., general contact center representatives) have been trained to handle client requests from type 3 clients 206. As illustrated by block 352 in FIG. 3B, the general service representative authenticates the client 9 in the same or similar way as previously discussed with respect to type 1 and type 2 clients in block 308. As illustrated by block 354, the general service representative also determines the client needs and begins to create a case for the client request using the case management tool 15 (e.g., case management interface 600 and case request information interface 650) as previously described. Block 356 illustrates that the general service representative determines if the client request is an international request for an account in an outside region or a domestic request for an account in the primary region. When the request is a domestic request the general service representative (e.g., general contact center representative) resolves the request or utilizes teams within the primary region to resolve the request, as illustrated by block 358. Decision block 360 illustrates that when the client request is an international request the general service representative (e.g., general contact center representative) determines if the client request is a multi-region request. As illustrated by block 362 when the request is a multi-region request the general service representative (e.g., general contact center representative) creates multiple cases for the request and links the cases together within the case management tool 15. However, when the case is a client request for a single outside region, the general service representative (e.g., general contact center representative) creates the case for the single account and region, as illustrated by block 364.

As illustrated by decision block 366 the general service representative (e.g., general contact center representative) determines if the client request is an FTR request or a non-FTR request. When the request is a non-FTR request a determination is made as to if entitlement is required, as illustrated by decision block 390. If entitlement is required then the general service representative or a document team 228 in charge of the entitlement documents communicates entitlement documents to the client 9, as illustrated by block 392. After the documents are complete or in the case when entitlement is not required, the case (or a portion thereof) is assigned to a specific general service representative (e.g., general research representative) for ownership, as illustrated by block 394. As previously discussed, as illustrated by block 396, the case is assigned to a workflow basket for which a workflow representative from a workflow team 230 will assign the case based on the assignment tool 17, and the process flow moves to “C1” in FIG. 3D as will be explained in further detail later.

Returning to block 366, when the request is an FTR request, then as illustrated by block 368, the general service representative (e.g., general contact center representative) works the request for resolution. As illustrated by block 370 if the case is resolved, the general service representative (e.g., general contact center representative) provides the resolution to the client 9 and closes the cases, as illustrated by block 372. Returning to decision block 370, if the general service representative (e.g., general contact center representative) cannot resolve the case by himself, he will contact the general international servicing team to help resolve the case, as illustrated by block 374 and as previously discussed with respect to block 332. The general service representative (e.g., general contact center representative) assigns a representative from the general international servicing team at least a portion of the case, as illustrated by block 376. As illustrated by block 378, if the general international service representative can resolve the portion of the case assigned then as illustrated by blocks 368 to 372 the general service representative (e.g., general contact center representative) receives the resolution from the general international service representative and communicates the resolution to the client 9. However, if the general international service representative cannot resolve the case immediately, then as illustrated by block 380, the general international service representative will continue to research the resolution for the assigned portion of the case. As illustrated by block 382, the general service representative monitors the resolution of the case using the case management tool 15, as previously discussed with respect to block 336. When the case (or portion of the assigned case) is identified as being resolved the general service representative (e.g., general contract center representative or other representative) provides the resolution of the case to the client 9, as illustrated by block 384. After presentation of the resolution to the client 9, the general service representative closes the case, as illustrated by block 386.

Returning to decision block 304 in FIG. 3A, when the communication from the client is an electronic written communication (e.g., e-mail, fax, instant message, or the like), as illustrated by block “B” the process moves to FIG. 3C illustrating a client electronic correspondence service process flow 400. As illustrated by decision block 402, a determination is made as to the type of client that initiated the communication. The type of client may be determined for example by the e-mail address of the client 9, the e-mail address to which the client 9 sent the communication, the fax number of the client 9, or the fax number to which the client 9 sent the fax. As illustrated by block 404, in one embodiment when the client is a type 1 client 202 or a type 2 client 204, a DSR (e.g., a DSD or DSC), or another like representative 7 may handle the client request directly. In some embodiments another representative 7 may review the client request and forward the request to the DSR or another representative 7 as needed. As illustrated by block 404, the DSR or other representative 7 authenticates the client, for example through the use of the client's e-mail address, stored contact information for the client, challenges questions, or the like. As further illustrated by block 404 the DSR or other representative 7 determines the client need from the electronic written correspondence (e.g., e-mail correspondence, fax, or the like). Decision block 406 illustrates that the DSR or other representative 7 determines if the client request is an international request for an outside region or a domestic request for the primary region. If the client request is associated with a domestic account request the DSR or other representative 7 handles the request alone or with the assistance of teams from the primary region, as illustrated by block 408. However, if the client request is an international request the DSR or other representative 7 switches his profile to the region in which the account associated with the client request is located. As illustrated by decision block 412 a determination is made as to whether or not the client request involves multiple accounts and/or multiple regions. As illustrated by block 414 if the client request is for a single region the DSR or other representative creates the case for the client request using the case management tool (e.g., case management interface 600 and case request information interface 650), as previously described. Alternatively, as illustrated by block 416 if the client request is for a multiple regions the DSR creates multiple cases and links the cases together. As illustrated by block 418 after the case is created ownership of the case is assigned to a DSR (e.g., to the current DSR, or another DSR).

As illustrated by decision block 420 a determination is made as to whether or not the client request is a FTR or non-FTR request. When the request is a non-FTR request a determination is made as to if entitlement is required, as illustrated by decision block 422. If entitlement is required then the DSR (or other representative 7), or a document team 228 in charge of the entitlement documents, communicates the entitlement documents to the client 9, as illustrated by block 424. After the documents are complete or in the case when entitlement is not required, the case (or a portion thereof) is assigned to a workflow basket for which a workflow representative from a workflow team 230 will assign the case based on the assignment tool 17, and the process flow moves to “C1” in FIG. 3D as will be explained in further detail later.

Returning to decision block 420 when the client request is an FTR request the DSR works to resolve the client request, as illustrated by block 428. As illustrated by block 430 if the DSR can resolve the client request then the DSR communicates the resolution to the client 9 during the initial call, as illustrated by block 432. Thereafter, as illustrated by block 434 the DSR closes the case. However, if the DSR cannot resolve the client request by himself, then as illustrated by block 436, the DSR will contact the general international servicing team 218 as previously discussed with respect to block 332. The DSR will assign a general international service representative a portion of the case to research and resolve, as illustrated by block 438. The DSR monitors the resolution of the case as illustrated by block 440 and as previously discussed with respect to 336. When the portion of the case is resolved the DSR communicates the resolution of the case to the client 9, as illustrated by block 432 and as previously discussed with respect to block 338. Thereafter, the DSR closes the case, as illustrated by block 434.

Returning to decision block 402, when the client is a type 3, or Nth type client, then as illustrated by block “C2” the process goes straight to the assignment process flow for various types of clients 500. Block “C2” in FIG. 3D illustrates all electronic written communications (e.g., e-mail, fax, or the like) received from type 3 or Nth type of clients. Block 520 of FIG. 3D, illustrates that a general service representative or another representative 7 that receives the client request assigns the client service request to a specific general service representative. As illustrated by block 522, the general service representative authenticates the electronic written communication (e.g., from type 3 206, or Nth type clients) and determines the client need, as previously described with respect to block 404 in FIG. 3C. The general service representative determines if the client request is an international request, as illustrated by decision block 524. When the client request is not an international request the case is resolved by the general service representative alone, or with the primary region teams, as illustrated by block 526. When the client request is an international request a determination is made as to if the client request is an FTR or non-FTR request, as illustrated by block 528. When the client request is an FTR request the general service representative works to resolve the client request, as illustrated by block 530. As illustrated by block 532 if the general service representative can resolve the client request then the general service representative communicates the resolution to the client 9, as illustrated by block 534 (e.g., through a return electronic written communication or a phone call). Thereafter, as illustrated by block 536 the general service representative closes the case. However, if the general service representative cannot resolve the client request by himself, then as illustrated by block 538, the general service representative will contact the general international servicing team as previously discussed with respect to block 332. The general service representative will assign a general international service representative a portion of the case to research and resolve, as illustrated by block 540. The general service representative monitors the resolution of the case as illustrated by block 542 and as previously discussed with respect to 336. When the portion of the case is resolved the general service representative communicates the resolution of the case to the client 9, as illustrated by block 534 and as previously discussed with respect to block 338. Thereafter, the general service representative closes the case, as illustrated by block 536.

Returning to block 528, when the request is a non-FTR request a determination is made as to if entitlement is required, as illustrated by decision block 550. If entitlement is required then the general service representative (or other representative 7), or a document team 228 in charge of the entitlement documents, communicates the entitlement documents to the client 9, as illustrated by block 552. After the documents are complete or in the case when entitlement is not required, the case (or a portion thereof) is assigned to a workflow basket for which a workflow representative from a workflow team 230 will assign the case based on the assignment tool 17, and the process flow moves to “C1” in FIG. 3D.

Block “C1” in FIG. 3D illustrates phone communications and written correspondence from all types of clients that require additional research. As illustrated by block 502 a workflow representative from the workflow team 230 accesses the workbasket in order to determine the outstanding cases that need additional research. As illustrated by block 504 the case is assigned to the proper representative 7 based on an assignment tool 17. As such, as illustrated by block 506, the case is assigned to a representative 7 from the general international servicing team 218 or a specific regional team (e.g., region 2 team 222, region 3 team 224, or Nth region team 226) to research and resolve the client request. The regional teams are trained for accounts located in each of the respective regions and also work the business hours of the each of the respective regions. Thereafter, the DSR or general service representative that owns the case monitors the resolution of the case using the case management tool 15, as illustrated by block 508. In other embodiments the general international servicing team 218 or a specific regional team sends a notification when the client request is resolved. When the client request is resolved the DSR or a general service representative communicates the resolution of the client request to a client, as illustrated by block 510. The DSR or a general service representative then closes the case, as illustrated by termination block 512. The regional teams are not available to resolve client requests during the hours of the primary region, and as such the client representative (e.g., DSR or general service representative) is used to monitor the resolution of the client request by the regional team representative and report the resolution of the client request to the client during the business hours of the client in the primary region.

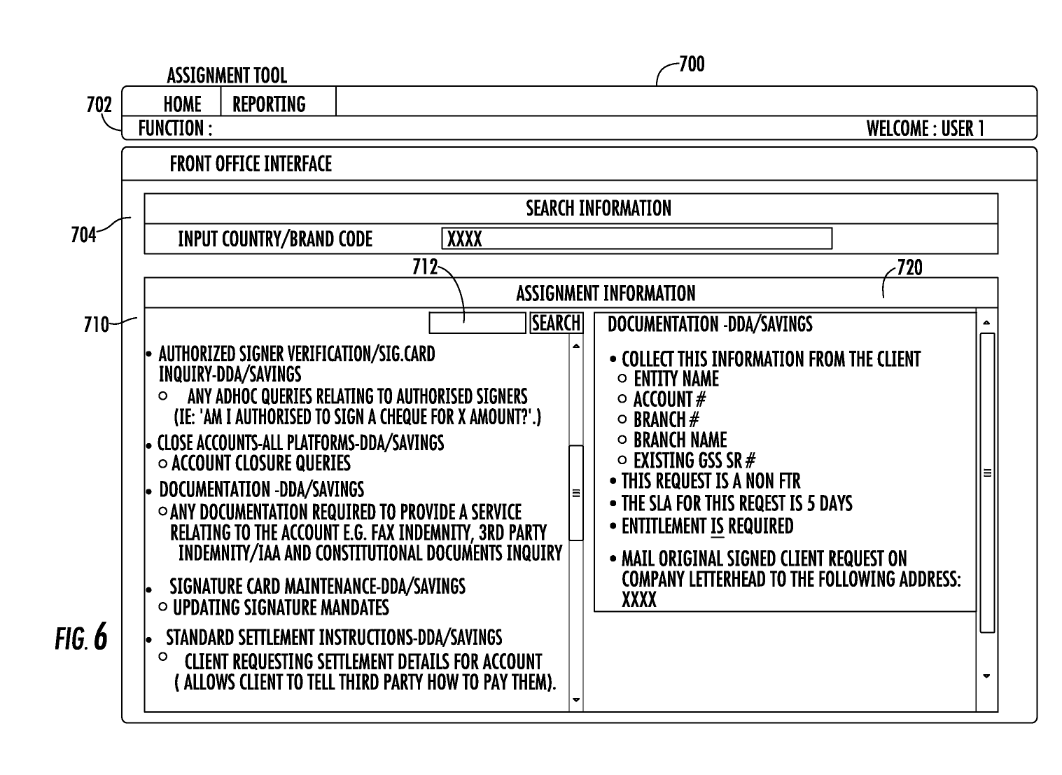

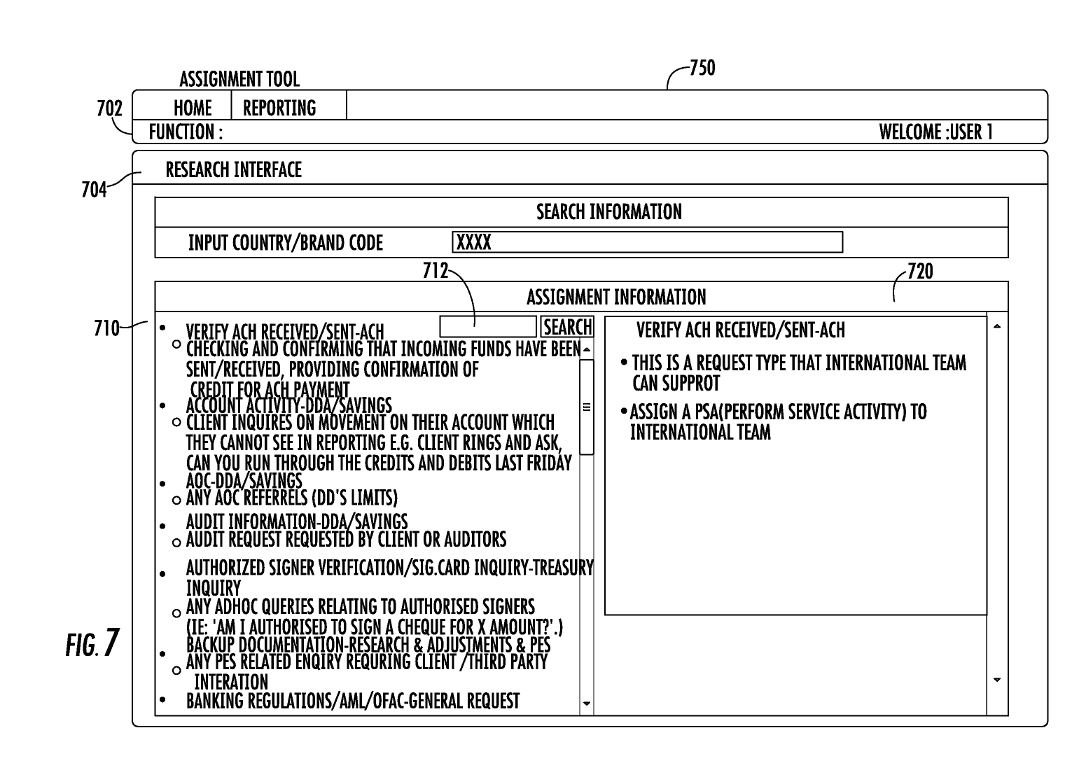

FIGS. 6 and 7 illustrate embodiments of the assignment tool 17, which may be utilized by a representative 7 (e.g., DSR, general service representative, workflow representative, or other like representative) in order to determine what information to collect for the case and where to assign a case for resolution. The assignment tool 17 assists the representatives 7 in determining where to route the cases during, before, and after the case details have been entered into the case management interface 600 and case request information interface 650, and as the representatives 7 work to resolve the cases. The assignment tool 17 provides information related to what information should be obtained from the client to resolve the case, the routing of FTR and non-FTR cases, the service level agreement information for the requirements for responding to the client request, and the entitlement requirements for client requests. In one embodiment of the invention the assignment tool 17 may have two difference interfaces, one for the client representatives and one for the researching representatives. Client representatives may use the front office interface 700 for resolving and routing client requests. Research representatives may use the research interface 750 for resolving and routing client requests to the general international team or the regional teams when necessary.

A representative 7 using the assignment tool 17 may first change the function of the assignment tool 17 between the front office interface 700 and the research interface 750 based on the role of the representative 7 (e.g., client representative or research representative). Once the desired interface is selected, a representative 7 may input a region or branch code for the account associated with the client request in a Region/Branch Code section 704. In some embodiments a drop-down list may be provided in response to the representative's input. The representative selects the desired region/branch associated with the client request. After the representative selects a region, a list of request types may be provided in a request type section 710 as illustrated in the front office interface 700 in FIG. 6. The representative 7 may select the request type listed in the request type section 710, or in other embodiments the representative 7 may search for a specific request type using a request type search 712. After the selection of a request type in the request type section 710, request details related to the request type are illustrated in a request detail section 720. The request detail section 720 includes specific request information that can be used to route and/or process the request. The request information for the front office interface 700 may include information that should be collected from the client or other channels, an indication if the request is a FTR or a non-FTR request, a SLA time limit requirement for the client request, entitlement requirements for the client request, and routing for the client request. Alternatively, the research interface 750 illustrated in FIG. 7 may have a request detail section 720 that provides information related to where the request should be routed, for example to the international team 218, or the specific regional teams associated with the regions in which the account associated with the client request is located.

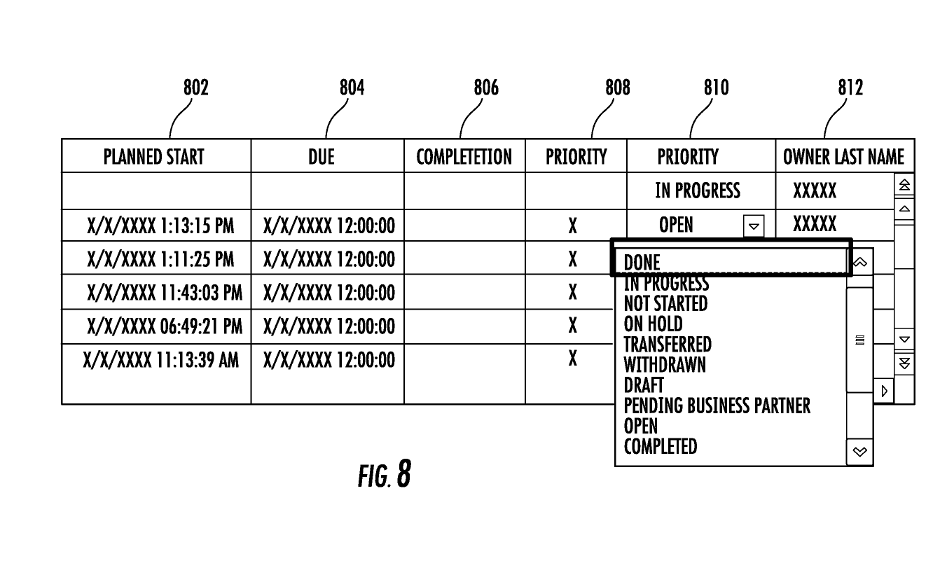

FIG. 8, illustrates an assignment interface 800 for the case management tool 15, which provides a list of the outstanding cases. The assignment interface 800 also provides an indication of the planned start date 802, the due date 804, the completed date 806, the priority 808, the status 810, and the owner 812 (e.g., the responsible representative 7) for each of the cases. The assignment interface 800 allows the representatives 7 to open, track, route, and close each of the cases related to the client requests. As such, using the combination of the case management tool 15 and the assignment tool 17 the representatives 7 can more efficiently handle client requests received from clients 9, while the clients 9 only have a single point of contact over the phone or through e-mail/fax to receive a resolution for a client request for any region in which the client has accounts.

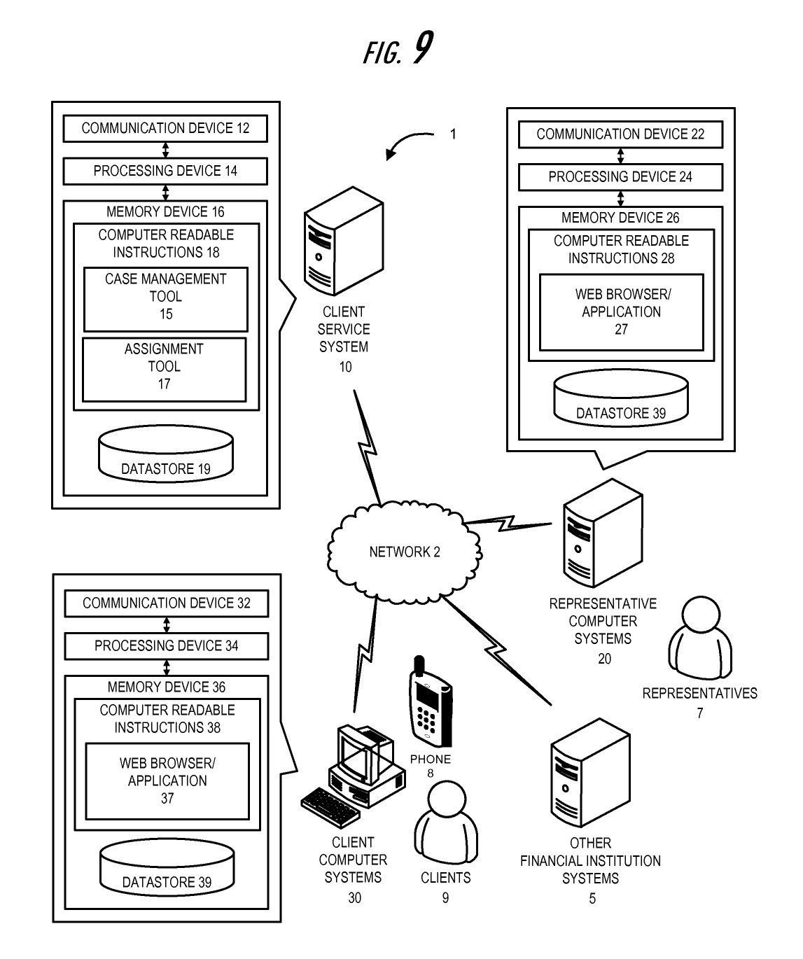

FIG. 9 illustrates a cross regional client service environment and system 1, in accordance with an embodiment of the present invention. As illustrated in FIG. 1, the client service system 10 is operatively coupled, via a network 2 to the representative computer systems 20, the client computer systems 30, and other financial institution systems 5. In this way, the client service system 10 can receive and send information from and to the representative computer systems 20, client computer systems 30, and other financial institution systems 5, such that representatives 7 can process client service requests from clients 9 timely and efficiently. FIG. 9 illustrates only one example of embodiments of a cross regional client service environment and system 1, and it will be appreciated that in other embodiments one or more of the systems (e.g., computers, mobile devices, servers, or other like systems) may be combined into a single system or be made up of multiple systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

As illustrated in FIG. 9, the client service system 10 generally comprises a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, representative computer systems 20, client computer systems 30, and other financial institution systems 30. As such, the communication device 12 generally comprises a modem, server, or other device for communicating with other devices on the network 2.

As further illustrated in FIG. 9, the client service system 10 comprises computer-readable instructions 18 stored in the memory device 16, which in one embodiment includes the computer-readable instructions 18 of a case management tool 15 and an assignment tool 17. In some embodiments, the memory device 16 includes a datastore 19 for storing data related to the client service system 10, including but not limited to data created and/or used by the case management tool 15 and the assignment tool 17. As discussed above the case management tool 15 allows the representatives 7 to open, populate, edit, assign, close, or the like cases for client requests. The assignment tool 17 allows the representatives 7 to determine the information needed to complete a client request, entitlement information, service level agreement information, routing information, and the like in order to respond to the client service request. The tools described herein may be applications that are at least partially stored on the client service system 10. In other embodiments a least a portion of the tools may be stored on other systems, such as on the representative computer systems 20. In still other embodiments the tools may be completely located on other systems.

As further illustrated in FIG. 9, the representative computer systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the client service system 10, the client computer systems 30, other financial institution servers 5, for the like. As such, the communication device 22 generally comprises a modem, server, or other device(s) for communicating with other devices on the network 2. In some embodiments, the memory device 26 includes a datastore 29 for storing data related to the representative computer systems 20, including but not limited to data created and/or used by the browser/application 27. The browser/application 27 allows the representatives 7 to access the case management tool 15 or the assignment tool 17 to create and resolve client requests.

As further illustrated in FIG. 9, the client computer systems 30 generally comprise a communication device 32, a processing device 34, and a memory device 36. The processing device 34 is operatively coupled to the communication device 32 and the memory device 36. The processing device 34 uses the communication device 32 to communicate with the network 2, and other devices on the network 2, such as, but not limited to, the client service system 10, representative computer system 20, other financial institution systems 5, or the like. As such, the communication device 32 generally comprises a modem, server, or other devices for communicating with other devices on the network 2, and a display, camera, keypad, mouse, keyboard, microphone, and/or speakers for communicating with one or more clients 9. The client computer systems 30 may include, for example, a personal computer, a laptop, a mobile device 8 (e.g., phone, smartphone, tablet, or personal display device (“PDA”), or the like) or other devices, or the like.

As illustrated in FIG. 9, the client computer systems 30 comprise computer-readable program instructions 38 stored in the memory device 36, which in one embodiment includes the computer-readable instructions 38 of a web browser/application 37. In some embodiments, the memory device 36 includes a datastore 39 for storing data related to the client computer systems 30, including but not limited to data created and/or used by a web browser/application 37. The web browser/application 37 allows the client 9 to communicate with the representatives 7, such as for example through the use of an e-mail account, fax number, messaging service in order to submit a client request to the representatives 7. In some embodiments a web browser is used to access websites, applications, or the like; however, in other embodiments a specific application (e.g., mobile application, computer application, or the like) is specifically configured to communicate with the representatives 7 through the representative computer systems 20.

The other financial institution systems 5 are operatively coupled to the client service system 10, the representative computer systems 20, the client computer systems 30, or the like through the network 2. The other financial institution systems 5 have devices the same or similar to the devices described for the client service system 10, representative computer systems 20, or the client computer systems 30 (e.g., communication device, processing device, memory device with computer-readable instructions, datastore, or the like). Thus, the other financial institution systems 5 communicate with the client service system 10, the representative computer systems 20, and client computer systems 30 in the same or similar way as previously described with respect to each system. The other financial institution systems 5, in some embodiments, are comprised of systems and devices that store and access account information or other information within or outside of the financial institution, such as for example account information stored for the clients 9 related to the accounts of the clients 9 in various regions across the globe.

It is understood that the systems and devices described herein illustrate one embodiment of the invention. It is further understood that one or more of the systems, devices, or the like can be combined in other embodiments and still function in the same or similar way as the embodiments described herein.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

U.S. patent application Ser. No. ______ to Snellings et al., entitled “Client Request Fulfillment Using a Case Management Tool,” which is filed concurrently herewith, is hereby incorporated by reference in its entirety.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A client request workflow assignment system, comprising:
a memory device; and
a processing device operatively coupled to the memory device, wherein the processing device is configured to execute computer-readable program code to:
receive an input for a region related to a client request, wherein the input for the region is received from a representative;
provide a client request type selection interface;
receive an input for a client request type, wherein the input for the client request type is received from the representative; and
provide a client request details interface, wherein the client request details interface provides client request information for routing the client request.

2. The client request workflow assignment system, wherein the processing device is further configured to execute computer-readable program code to:
receive an input indicating a representative type, wherein the representative type is a client representative or a research representative; and wherein the representative type is used to determine the client request information provided to the representative for routing the client request.

3. The client request workflow assignment system of claim 2, wherein the client request information for the client request displayed to the client representative comprises information to collect from the client, a first touch resolution or a non-first touch resolution indication, a service level agreement time limit, entitlement requirements, and routing information.

4. The client request workflow assignment system of claim 2, wherein when the client request is received through a phone call and the request type is a first touch resolution then the client request information indicates that the client representative can resolve the request or the client representative can contact a general international team to resolve the request; or wherein when the client request is received through the phone call and the request type is a non-first touch resolution then the client request information indicates that the client representative should assign the request to a workflow research team for routing.

5. The client request workflow assignment system of claim 2, wherein when the client request is received through an electronic written communication and the client request can be handled by the client representative the client request is resolved by the client representative; or wherein when the client request is received through the electronic written communication and the client representative is unable to handle the client request then the client request information indicates that the client representative should assign the request to a workflow research team for routing.

6. The client request workflow assignment system of claim 2, wherein the client request information for the client request displayed to the research representative comprises a regional team or a general international team to which the research representative should route the request.

7. The client request workflow assignment system of claim 2, wherein the client request information for the client request displayed to the research representative comprises how to update a case in a case management tool before routing the client request to a regional team or a general international team.

8. A computer program product for a client request workflow assignment system, the computer program product comprising at least one non-transitory computer-readable medium having computer-readable program code portions embodied therein, the computer-readable program code portions comprising:
an executable portion configured to receive an input for a region related to a client request, wherein the input for the region is received from a representative;
an executable portion configured to provide a client request type selection interface;
an executable portion configured to receive an input for a client request type, wherein the input for the client request type is received from the representative; and
an executable portion configured to provide a client request details interface, wherein the client request details interface provides client request information for routing the client request.

9. The computer program product of claim 8, wherein the computer-readable program code portions further comprise:
an executable portion configured to receive an input indicating a representative type, wherein the representative type is a client representative or a research representative; and wherein the representative type is used to determine the client request information provided to the representative for routing the client request.

10. The computer program product of claim 9, wherein the client request information for the client request displayed to the client representative comprises information to collect from the client, a first touch resolution or a non-first touch resolution indication, a service level agreement time limit, entitlement requirements, and routing information.

11. The computer program product of claim 9, wherein when the client request is received through a phone call and the request type is a first touch resolution then the client request information indicates that the client representative can resolve the request or the client representative can contact a general international team to resolve the request; or wherein when the client request is received through the phone call and the request type is a non-first touch resolution then the client request information indicates that the client representative should assign the request to a workflow research team for routing.

12. The computer program product of claim 9, wherein when the client request is received through an electronic written communication and the client request can be handled by the client representative the client request is resolved by the client representative; or wherein when the client request is received through the electronic written communication and the client representative is unable to handle the client request then the client request information indicates that the client representative should assign the request to a workflow research team for routing.

13. The computer program product of claim 9, wherein the client request information for the client request displayed to the research representative comprises a regional team or a general international team to which the research representative should route the request.

14. The computer program product of claim 9, wherein the client request information for the client request displayed to the research representative comprises how to update a case in a case management tool before routing the client request to a regional team or a general international team.

15. A client request workflow assignment method, comprising:
receiving, by a processing device, an input for a region related to a client request, wherein the input for the region is received from a representative;
providing, by the processing device, a client request type selection interface;
receiving, by the processing device, an input for a client request type, wherein the input for the client request type is received from the representative; and
providing, by the processing device, a client request details interface, wherein the client request details interface provides client request information for routing the client request.

16. The client request workflow assignment method of claim 15, further comprising:
receiving, by the processing device, an input indicating a representative type, wherein the representative type is a client representative or a research representative; and wherein the representative type is used to determine the client request information provided to the representative for routing the client request.

17. The client request workflow assignment method of claim 16, wherein the client request information for the client request displayed to the client representative comprises information to collect from the client, a first touch resolution or a non-first touch resolution indication, a service level agreement time limit, entitlement requirements, and routing information.

18. The client request workflow assignment method of claim 16, wherein when the client request is received through a phone call and the request type is a first touch resolution then the client request information indicates that the client representative can resolve the request or the client representative can contact a general international team to resolve the request; or wherein when the client request is received through the phone call and the request type is a non-first touch resolution then the client request information indicates that the client representative should assign the request to a workflow research team for routing.

19. The client request workflow assignment method of claim 16, wherein when the client request is received through an electronic written communication and the client request can be handled by the client representative the client request is resolved by the client representative; or wherein when the client request is received through the electronic written communication and the client representative is unable to handle the client request then the client request information indicates that the client representative should assign the request to a workflow research team for routing.

20. The client request workflow assignment method of claim 16, wherein the client request information for the client request displayed to the research representative comprises a regional team or a general international team to which the research representative should route the request; and wherein the client request information for the client request displayed to the research representative comprises how to update a case in a case management tool before routing the client request to the regional team or the general international team.
